(19) United States
(12) Patent Application Publication
(10) Pub. No.: US 2007/0279536 A1
(43) Pub. Date: Dec. 6, 2007

(54) Arrangement for and method of projecting an image to be viewed over extended viewing range

(76) Inventors: Chinh Tan, Setauket, NY (US); Dmitriy Yavid, Stony Brook, NY (US); Miklos Stern, Woodmere, NY (US)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/446,755

(22) Filed: Jun. 5, 2006

(51) Int. Cl. H04N 5/74

(52) U.S. Cl. 348/750

(57) ABSTRACT

A laser beam is swept by a scan mirror as a pattern of scan lines on a projection surface. Selected pixels arranged along each scan line are illuminated to produce an image. The laser beam is optically modified to form each scan line with a desired high resolution having no less than a desired large number of the pixels over an extended viewing range, by focusing the laser beam to form a beam waist having a scan dimension proportional to the resolution at a focal location positioned between the scan mirror and the projection surface.

### BACKGROUND OF THE INVENTION

1. Field of the Invention

The present invention generally relates to projecting a two-dimensional image, especially in color, to be viewed on a projection surface over an extended viewing range.

2. Description of the Related Art

It is generally known to project a two-dimensional image from an image projection arrangement on a projection surface based on a pair of scan mirrors which oscillate in mutually orthogonal directions to scan a laser beam over a raster pattern comprised of a plurality of scan lines, each scan line having a number of pixels. The image is created in the raster pattern by energizing or pulsing a laser on and off at selected times, thereby illuminating selected pixels with a beam spot and not illuminating other pixels in each scan line. The number of distinct beam spots or pixels that can fit in each scan line is known as the resolution.

For a clear and sharp image, it is desirable if the resolution is high and can be maintained high over an extended viewing range in which the image can be viewed. It is also desirable for the extended viewing range to start at a close-in starting location near the image projection arrangement where the projected image is relatively brighter as compared to a far-away location where the projected image is relatively dimmer.

### SUMMARY OF THE INVENTION

### Objects of the Invention

Accordingly, it is a general object of this invention to provide an image projection arrangement that projects a two-dimensional image, especially in color, of high resolution on a projection surface over an extended viewing range in accordance with the method of this invention.

An additional object is to provide a miniature, compact, lightweight, and portable color image projection module useful in many instruments of different form factors.

### FEATURES OF THE INVENTION

In keeping with these objects and others, which will become apparent hereinafter, one feature of this invention resides, briefly stated, in an image projection arrangement for, and a method of, projecting a two-dimensional image of high resolution, especially in color, to be viewed on a projection surface over an extended viewing range. The arrangement includes a laser assembly for generating a laser beam; a scanner including a scan mirror oscillatable about a scan axis, for sweeping the laser beam as a pattern of scan lines during oscillation of the scan mirror on the projection surface at a distance within the extended viewing range, each scan line having a plurality of pixels; and a controller operatively connected to the laser assembly and the scanner, for causing selected pixels to be illuminated, and rendered visible, by the laser beam to produce the image.

In accordance with one aspect of this invention, the laser beam is optically modified by optics to form each scan line with a desired high resolution having no less than a desired large number of the pixels over the extended viewing range, by focusing the laser beam to form a beam waist having a scan dimension proportional to the resolution at a focal location positioned between the scan mirror and the projection surface. As defined herein, the scan dimension is the dimension of the waist along the scan direction. In the case of a circular beam waist, the scan dimension is the diameter. In the preferred embodiment, the optics includes a lens having at least one aspheric surface. By maintaining the desired high resolution over the extended viewing range, the projected image is always sharp and clear.

In the preferred embodiment, the laser assembly includes a plurality of lasers for respectively generating a plurality of laser beams of different wavelengths, for example, red, blue and green laser beams. The optics includes an aspheric lens provided for optically modifying each laser beam. The optics is also operative for nearly collinearly arranging the laser beams to form the laser beam as a composite beam that is directed to the scan mirror. The scan mirror is operative for sweeping the composite beam along a first direction at a first scan rate and over a first scan angle. Another oscillatable scan mirror is operative for sweeping the composite beam along a second direction substantially perpendicular to the first direction, and at a second scan rate different from the first scan rate, and at a second scan angle different from the first scan angle. At least one of the scan mirrors is oscillated by an inertial drive.

The controller includes means for energizing the laser assembly to illuminate the selected pixels, and for deenergizing the laser assembly to non-illuminate pixels other than the selected pixels. The controller also includes means for effectively aligning the laser beams collinearly by delaying turning on and off the pixels of each of the laser beams relative to each other.

It is advantageous if a support is provided for at least supporting the laser assembly, the scanner, and the optics. The support, lasers, scanner, controller and optics preferably occupy a volume of about seventy cubic centimeters, thereby constituting a compact module, which is interchangeably mountable in housings of different form factors, including, but not limited to, a pen-shaped, gun-shaped or flashlight-shaped instrument, a personal digital assistant, a pendant, a watch, a computer, and, in short, any shape due to its compact and miniature size. The projected image can be used for advertising or signage purposes, or for a television or computer monitor screen, and, in short, for any purpose desiring something to be displayed.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a hand-held instrument projecting an image at a working distance therefrom;

FIG. 2 is an enlarged, overhead, perspective view of an image projection arrangement in accordance with this invention for installation in the instrument of FIG. 1;

FIG. 3 is a top plan view of the arrangement of FIG. 2;

FIG. 4 is a perspective front view of an inertial drive for use in the arrangement of FIG. 2;

FIG. 5 is a perspective rear view of the inertial drive of FIG. 4;

FIG. 6 is a perspective view of a practical implementation of the arrangement of FIG. 2;

FIG. 7 is an electrical schematic block diagram depicting operation of the arrangement of FIG. 2;

FIG. 8 is a diagrammatic view depicting the operation of the optics used in the image projection arrangement of FIG. 2; and

FIG. 9 is a plot of two graphs depicting resolution versus distance away from a scan mirror used in the image projection arrangement of FIG. 2, one graph depicting the situation in which the laser beam is focused on the scan mirror, and the other graph depicting the situation in which the laser beam is focused between the scan mirror and a remote projection surface in accordance with this invention.

### DETAILED DESCRIPTION OF THE PREFERRED EMBODIMENTS

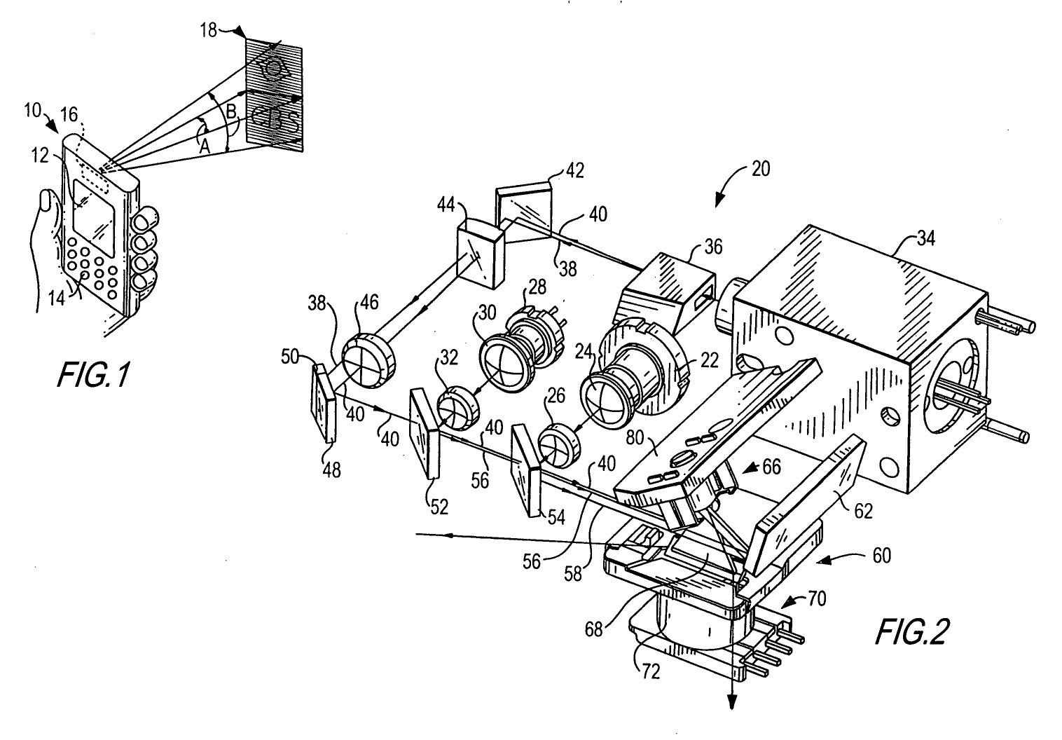

Reference numeral 10 in FIG. 1 generally identifies a hand-held instrument, for example, a personal digital assistant, in which a lightweight, compact, image projection arrangement 20, as shown in FIG. 2, is mounted and operative for projecting a two-dimensional color image on a projection surface located anywhere within an extended range of viewing distances from the instrument. By way of example, an image 18 is situated at a distance within the extended range of viewing distances relative to the instrument 10.

As shown in FIG. 1, the image 18 extends over an optical horizontal scan angle A extending along the horizontal direction, and over an optical vertical scan angle B extending along the vertical direction, of the image. As described below, the image is comprised of illuminated and non-illuminated pixels on a raster pattern of scan lines swept by a scanner in the arrangement 20.

The parallelepiped shape of the instrument 10 represents just one form factor of a housing in which the arrangement 20 may be implemented. The instrument can be shaped with many different form factors, such as a pen, a cellular telephone, a clamshell or a wristwatch.

In the preferred embodiment, the arrangement 20 measures about seventy cubic centimeters in volume. This compact, miniature size allows the arrangement 20 to be mounted in housings of many diverse shapes, large or small, portable or stationary, including some having an on-board display 12, a keypad 14, and a window 16 through which the image is projected.

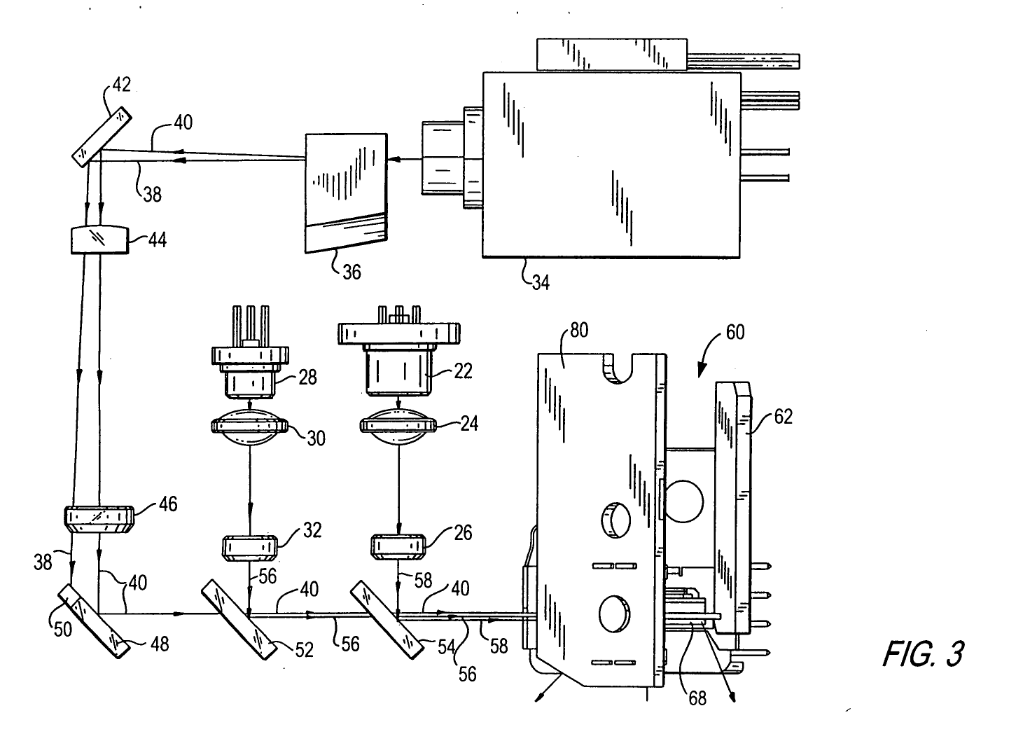

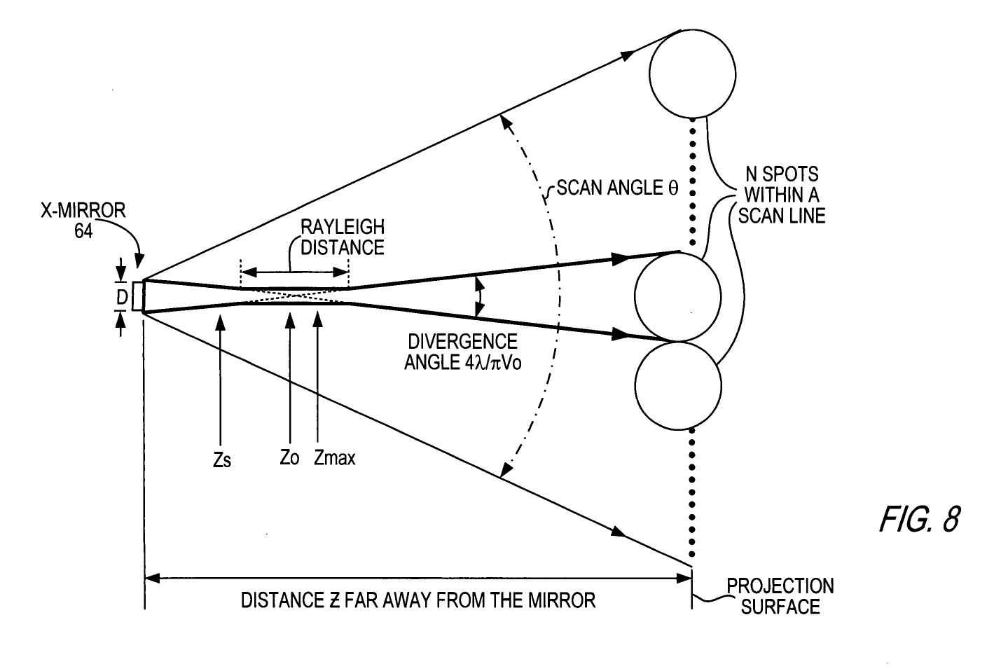

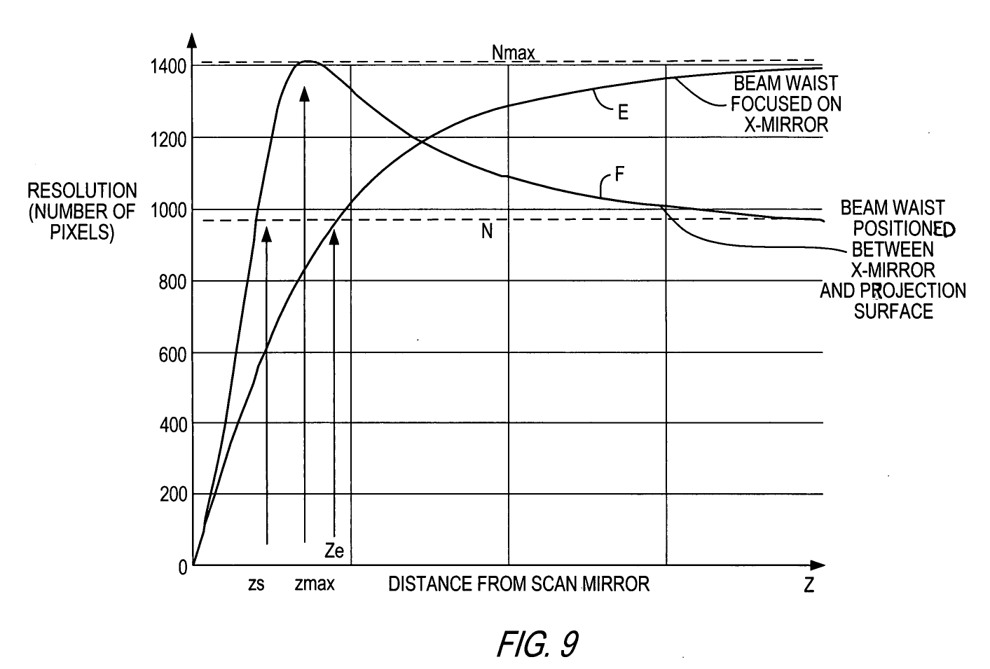

Referring to FIGS. 2 and 3, the arrangement 20 includes a solid-state, preferably a semiconductor laser 22 which, when energized, emits a bright red laser beam at about 635-655 nanometers. Lens 24 is a bi-aspheric convex lens having a positive focal length and is operative for collecting virtually all the energy in the red beam and for producing a diffraction-limited beam. Lens 26 is a concave lens having a negative focal length. Lenses 24, 26 are held by non-illustrated respective lens holders apart on a support (not illustrated in FIG. 2 for clarity) inside the instrument 10. The lenses 24, 26 shape the red beam profile over the extended range of viewing distances. The role of the bi-aspheric convex lens 24 in optically modifying the red beam in connection with this invention is described below in connection with FIGS. 8-9.

Another solid-state, semiconductor laser 28 is mounted on the support and, when energized, emits a diffraction-limited blue laser beam at about 440 nanometers. Another bi-aspheric convex lens 30 and a concave lens 32 are employed to shape the blue beam profile in a manner analogous to lenses 24, 26. The role of the bi-aspheric convex lens 30 in optically modifying the blue beam in connection with this invention is also described below in connection with FIGS. 8-9.

A green laser beam having a wavelength on the order of 532 nanometers is generated not by a semiconductor laser, but instead by a green module 34 having an infrared diode-pumped, Nd-doped, YAG crystal laser whose output beam at 1064 nanometers. A non-linear frequency doubling crystal is included in the infrared laser cavity between two laser mirrors. Since the infrared laser power inside the cavity is much larger than the power coupled outside the cavity, the frequency doubler is more efficient in generating the double frequency green light inside the cavity. The output mirror of the laser is reflective to the 1064 nm infrared radiation, and transmissive to the doubled 532 nm green laser beam. Since the correct operation of the solid-state laser and frequency doubler require precise temperature control, a semiconductor device relying on the Peltier effect is used to control the temperature of the green laser module. The thermo-electric cooler can either heat or cool the device depending on the polarity of the applied current. A thermistor is part of the green laser module in order to monitor its temperature. The readout from the thermistor is fed to a controller, which adjusts the control current to the thermoelectric cooler accordingly.

As explained below, the lasers are pulsed in operation at frequencies on the order of 100 MHz. The red and blue semiconductor lasers 22, 28 can be pulsed directly via the applied drive currents at such high frequencies, but the currently available green solid-state lasers cannot. As a result, the green laser beam exiting the green module 34 is pulsed with an acousto-optical modulator 36 that creates an acoustic traveling wave inside a crystal for diffracting the green beam. The modulator 36, however, produces a zero-order, non-diffracted beam 38 and a first-order, pulsed, diffracted beam 40. The beams 38, 40 diverge from each other and, in order to separate them to eliminate the undesirable zero-order beam 38, the beams 38, 40 are routed along a long, folded path having a folding mirror 42. Alternatively, an electro-optical modulator can be used either externally or internally to the green laser module to pulse the green laser beam. Other possible ways to modulate the green laser beam include electro-absorption modulation, or Mach-Zender interferometer. The beams 38, 40 are routed through positive and negative lenses 44, 46. However, only the diffracted green beam 40 is allowed to impinge upon, and reflect from, the folding mirror 48. The non-diffracted beam 38 is absorbed by an absorber 50, preferably mounted on the mirror 48.

The arrangement includes a pair of dichroic filters 52, 54 arranged to make the green, blue and red beams as collinear as possible before reaching a scanning assembly 60. Filter 52 allows the green beam 40 to pass therethrough, but the blue beam 56 from the blue laser 28 is reflected by the interference effect. Filter 54 allows the green and blue beams 40, 56 to pass therethrough, but the red beam 58 from the red laser 22 is reflected by the interference effect.

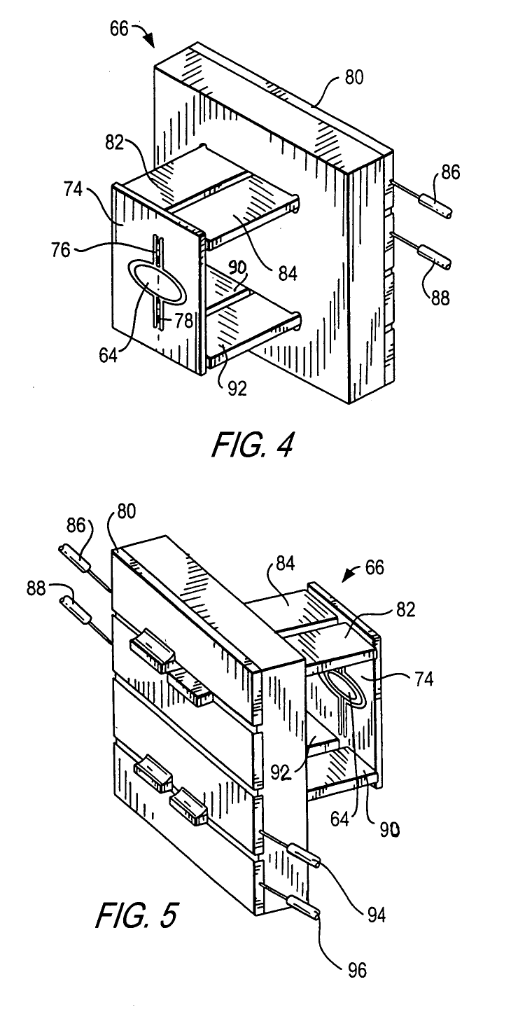

The nearly collinear beams 40, 56, 58 are directed to, and reflected off, a stationary fold mirror 62. The scanning assembly 60 includes a first scan mirror 64 oscillatable by an inertial drive 66 (shown in isolation in FIGS. 4-5) at a first scan rate to sweep the laser beams reflected off the fold mirror 62 over the first horizontal scan angle A, and a second scan mirror 68 oscillatable by an electromagnetic drive 70 at a second scan rate to sweep the laser beams reflected off the first scan mirror 64 over the second vertical scan angle B. In a variant construction, the scan mirrors 64, 68 can be replaced by a single two-axis mirror.

The inertial drive 66 is a high-speed, low electrical power-consuming component. Details of the inertial drive can be found in U.S. patent application Ser. No. 10/387,878, filed Mar. 13, 2003, assigned to the same assignee as the instant application, and incorporated herein by reference thereto. The use of the inertial drive reduces power consumption of the scanning assembly 60 to less than one watt and, in the case of projecting a color image, as described below, to less than ten watts.

The drive 66 includes a movable frame 74 for supporting the scan mirror 64 by means of a hinge that includes a pair of collinear hinge portions 76, 78 extending along a hinge axis and connected between opposite regions of the scan mirror 64 and opposite regions of the frame. The frame 74 need not surround the scan mirror 64, as shown.

The frame, hinge portions and scan mirror are fabricated of an integral, generally planar, silicon substrate, which is approximately 150μ thick. The silicon is etched to form omega-shaped slots having upper parallel slot sections, lower parallel slot sections, and U-shaped central slot sections. The scan mirror 64 preferably has an oval shape and is free to move in the slot sections. In the preferred embodiment, the dimensions along the axes of the oval-shaped scan mirror measure 749 microns ×1600 microns. Each hinge portion measures 27 microns in width and 1130 microns in length. The frame has a rectangular shape measuring 3100 microns in width and 4600 microns in length.

The inertial drive is mounted on a generally planar, printed circuit board 80 and is operative for directly moving the frame and, by inertia, for indirectly oscillating the scan mirror 64 about the hinge axis. One embodiment of the inertial drive includes a pair of piezoelectric transducers 82, 84 extending perpendicularly of the board 80 and into contact with spaced apart portions of the frame 74 at either side of hinge portion 76. An adhesive may be used to insure a permanent contact between one end of each transducer and each frame portion. The opposite end of each transducer projects out of the rear of the board 80 and is electrically connected by wires 86, 88 to a periodic alternating voltage source (not shown).

In use, the periodic signal applies a periodic drive voltage to each transducer and causes the respective transducer to alternatingly extend and contract in length. When transducer 82 extends, transducer 84 contracts, and vice versa, thereby simultaneously pushing and pulling the spaced apart frame portions and causing the frame to twist about the hinge axis. The drive voltage has a frequency corresponding to the resonant frequency of the scan mirror. The scan mirror is moved from its initial rest position until it also oscillates about the hinge axis at the resonant frequency. In a preferred embodiment, the frame and the scan mirror are about 150 microns thick, and the scan mirror has a high Q factor. A movement on the order of 1 micron by each transducer can cause oscillation of the scan mirror at scan angles in excess of 15 degrees.

Another pair of piezoelectric transducers 90, 92 extends perpendicularly of the board 80 and into permanent contact with spaced apart portions of the frame 74 at either side of hinge portion 78. Transducers 90, 92 serve as feedback devices to monitor the oscillating movement of the frame and to generate and conduct electrical feedback signals along wires 94, 96 to a feedback control circuit (not shown).

Although light can reflect off an outer surface of the scan mirror, it is desirable to coat the surface of the mirror 64 with a specular coating made of gold, silver, aluminum, or a specially designed highly reflective dielectric coating.

The electromagnetic drive 70 includes a permanent magnet jointly mounted on and behind the second scan mirror 68, and an electromagnetic coil 72 operative for generating a periodic magnetic field in response to receiving a periodic drive signal. The coil 72 is adjacent the magnet so that the periodic field magnetically interacts with the permanent field of the magnet and causes the magnet and, in turn, the second scan mirror 68 to oscillate.

The inertial drive 66 oscillates the scan mirror 64 at a high speed at a scan rate preferably greater than 5 kHz and, more particularly, on the order of 18 kHz or more. This high scan rate is at an inaudible frequency, thereby minimizing noise and vibration. The electromagnetic drive 70 oscillates the scan mirror 68 at a slower scan rate on the order of 40 Hz which is fast enough to allow the image to persist on a human eye retina without excessive flicker.

The faster mirror 64 sweeps a generally horizontal scan line, and the slower mirror 68 sweeps the generally horizontal scan line vertically, thereby creating a raster pattern which is a grid or sequence of roughly parallel scan lines from which the image is constructed. Each scan line has a number of pixels. The image resolution is preferably XGA quality of 1024×768 pixels. A high-definition television standard, denoted 720p, 1270×720 pixels, can also be obtained. In some applications, a one-half VGA quality of 320×480 pixels, or one-fourth VGA quality of 320×240 pixels, is sufficient. At minimum, a resolution of 160×160 pixels is desired.

The roles of the mirrors 64, 68 could be reversed so that mirror 68 is the faster, and mirror 64 is the slower. Mirror 64 can also be designed to sweep the vertical scan line, in which event, mirror 68 would sweep the horizontal scan line. Also, the inertial drive can be used to drive the mirror 68. Indeed, either mirror can be driven by an electromechanical, electrical, mechanical, electrostatic, magnetic, or electromagnetic drive.

The slow-mirror is operated in a constant velocity sweep-mode during which time the image is displayed. During the mirror's return, the mirror is swept back into the initial position at its natural frequency, which is significantly higher. The mirror can also be driven back. During the mirror's return trip, the lasers can be powered down in order to reduce the power consumption of the device.

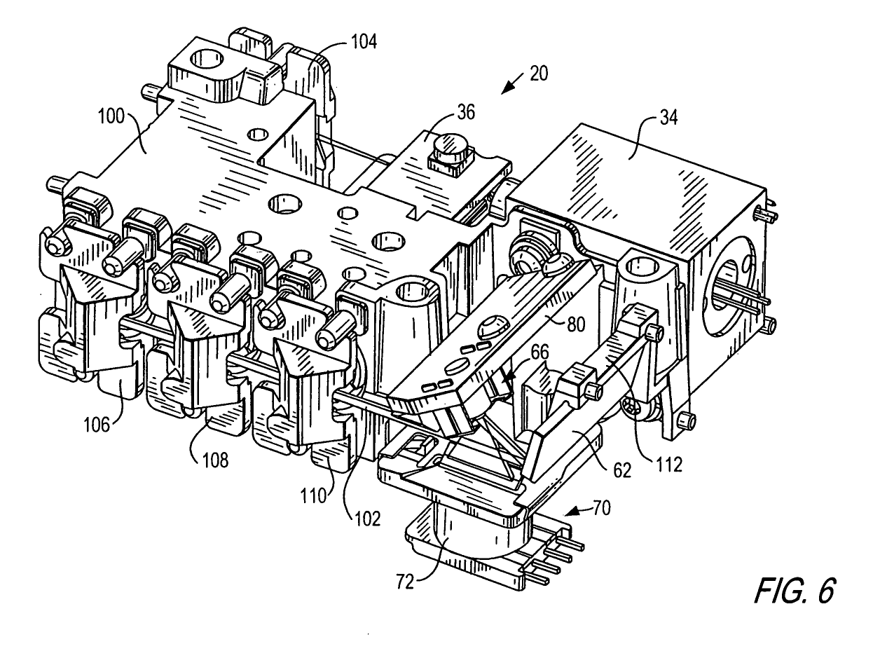

FIG. 6 is a practical implementation of the arrangement 20 in the same perspective as that of FIG. 2. The aforementioned components are mounted on a support, which includes a top cover 100 and a support plate 102. Holders 104, 106, 108, 110, 112 respectively hold folding mirrors 42, 48, filters 52, 54 and fold mirror 62 in mutual alignment. Each holder has a plurality of positioning slots for receiving positioning posts stationarily mounted on the support. Thus, the mirrors and filters are correctly positioned. As shown, there are three posts, thereby permitting two angular adjustments and one lateral adjustment. Each holder can be glued in its final position.

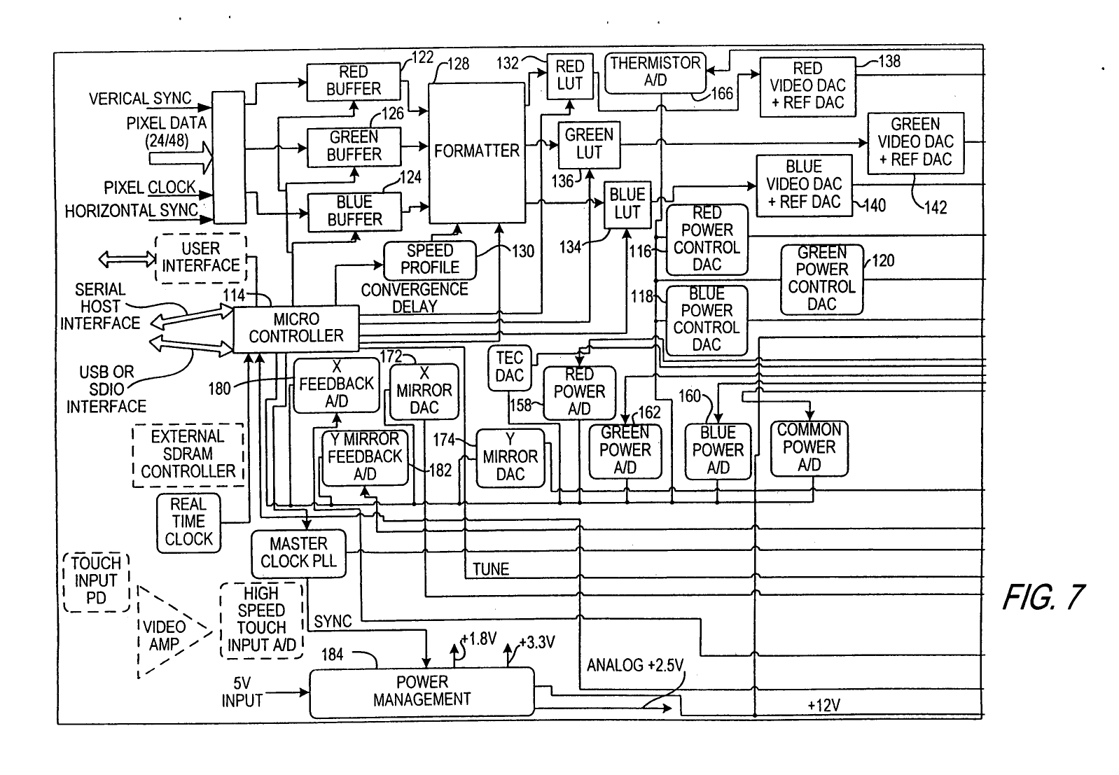

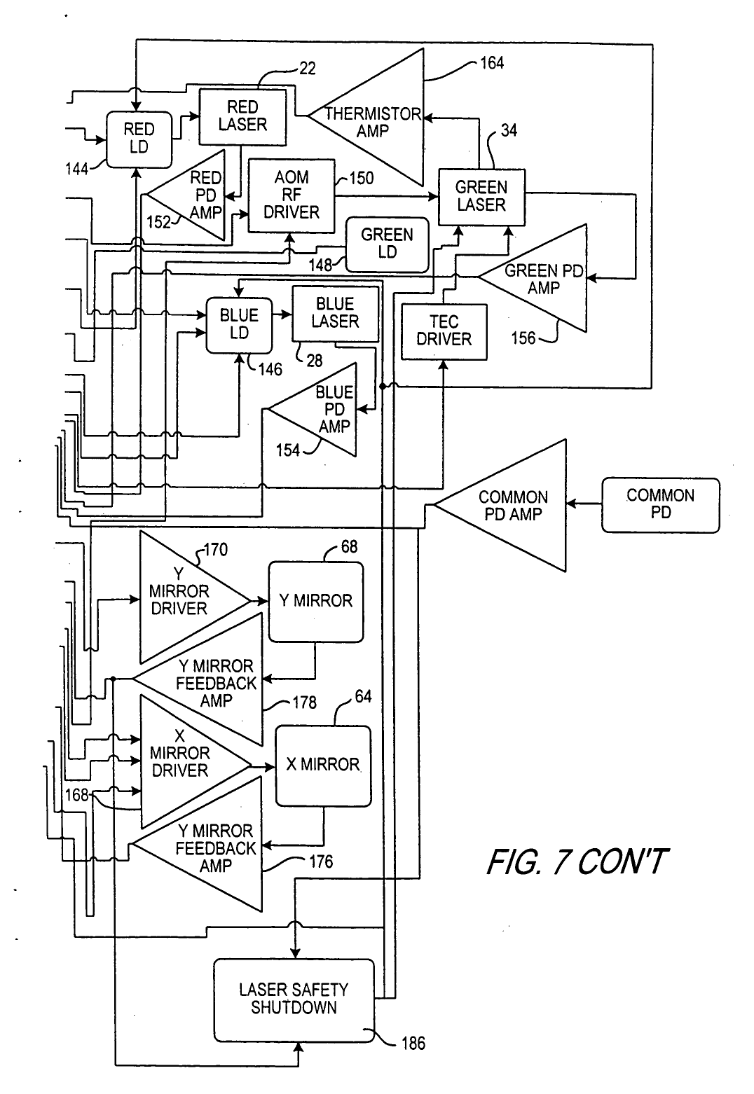

The image is constructed by selective illumination of the pixels in one or more of the scan lines. As described below in greater detail with reference to FIG. 7, a controller 114 causes selected pixels in the raster pattern to be illuminated, and rendered visible, by the three laser beams. For example, red, blue and green power controllers 116, 118, 120 respectively conduct electrical currents to the red, blue and green lasers 22, 28, 34 to energize the latter to emit respective light beams at each selected pixel, and do not conduct electrical currents to the red, blue and green lasers to deenergize the latter to non-illuminate the other non-selected pixels. The resulting pattern of illuminated and non-illuminated pixels comprises the image, which can be any display of human- or machine-readable information or graphic.

Referring to FIG. 1, the raster pattern is shown in an enlarged view. Starting at an end point, the laser beams are swept by the inertial drive along the generally horizontal direction at the horizontal scan rate to an opposite end point to form a scan line. Thereupon, the laser beams are swept by the electromagnetic drive 70 along the vertical direction at the vertical scan rate to another end point to form a second scan line. The formation of successive scan lines proceeds in the same manner.

The image is created in the raster pattern by energizing or pulsing the lasers on and off at selected times under control of the microprocessor 114 or control circuit by operation of the power controllers 116, 118, 120. The lasers produce visible light and are turned on only when a pixel in the desired image is desired to be seen. The color of each pixel is determined by one or more of the colors of the beams. Any color in the visible light spectrum can be formed by the selective superimposition of one or more of the red, blue, and green lasers. The raster pattern is a grid made of multiple pixels on each line, and of multiple lines. The image is a bit-map of selected pixels. Every letter or number, any graphical design or logo, and even machine-readable bar code symbols, can be formed as a bit-mapped image.

As shown in FIG. 7, an incoming video signal having vertical and horizontal synchronization data, as well as pixel and clock data, is sent to red, blue and green buffers 122, 124, 126 under control of the microprocessor 114. The storage of one full VGA frame requires many kilobytes, and it would be desirable to have enough memory in the buffers for two full frames to enable one frame to be written, while another frame is being processed and projected. The buffered data is sent to a formatter 128 under control of a speed profiler 130 and to red, blue and green look up tables (LUTs) 132, 134, 136 to correct inherent internal distortions caused by scanning, as well as geometrical distortions caused by the angle of the display of the projected image. The resulting red, blue and green digital signals are converted to red, blue and green analog signals by digital to analog converters (DACs) 138, 140, 142. The red and blue analog signals are fed to red and blue laser drivers (LDs) 144, 146 which are also connected to the red and blue power controllers 116, 118. The green analog signal is fed to an acousto-optical module (AOM) radio frequency (RF) driver 150 and, in turn, to the green laser 34 which is also connected to a green LD 148 and to the green power controller 120.

Feedback controls are also shown in FIG. 7, including red, blue and green photodiode amplifiers 152, 154, 156 connected to red, blue and green analog-to-digital (A/D) converters 158, 160, 162 and, in turn, to the microprocessor 114. Heat is monitored by a thermistor amplifier 164 connected to an A/D converter 166 and, in turn, to the microprocessor.

The scan mirrors 64, 68 are driven by drivers 168, 170 which are fed analog drive signals from DACs 172, 174 which are, in turn, connected to the microprocessor. Feedback amplifiers 176, 178 detect the position of the scan mirrors 64, 68, and are connected to feedback A/Ds 180, 182 and, in turn, to the microprocessor.

A power management circuit 184 is operative to minimize power while allowing fast on-times, preferably by keeping the green laser on all the time, and by keeping the current of the red and blue lasers just below the lasing threshold.

A laser safety shut down circuit 186 is operative to shut the lasers off if either of the scan mirrors 64, 68 is detected as being outside of rated values.

Turning now to FIG. 8, the aforementioned lenses 24, 30 for the red and blue beams are operative for optically modifying the respective laser beam to form each scan line with a desired high resolution having no less than a desired large number of the pixels over the extended viewing range, by focusing the respective laser beam to form a beam waist having a scan dimension proportional to the resolution at a focal location positioned between the scan mirror 64 and the projection surface. This situation is schematically shown in FIG. 8 and graphically depicted by curve F in FIG. 9.

Thus, in FIG. 8, each beam spot or pixel is represented by a circle for simplicity, and the resolution N is the number of distinct pixels on each scan line. The X-mirror 64 has a size D and is oscillated at a scan angle θ. The distance z identifies the distance away from the X-mirror 64 to the projection surface. The beam has a wavelength λ and is focused to a beam waist having a scan dimension Wo at a focal location Zo. The Rayleigh distance is defined as the location at which the scan dimension Wo is 1.414 times greater than Wo. The location at which the resolution is a maximum value is Zmax. The starting location Zs is the start of the extended range of viewing distances wherein the resolution is not less than a desired value. The divergence angle of the laser beam is 4 λ/πWo.

In FIG. 9, the curve E depicts the variation of resolution versus distance away from the X-mirror in the situation wherein the laser beam is focused to form the beam waist on the X-mirror 64. Curve E demonstrates that the resolution increases as a function of distance Z and eventually reaches a maximum value Nmax (e.g., about 1400 pixels) very far from the X-mirror. The desired high resolution N (e.g., slightly under 1000 pixels) crosses the curve E at a starting location Ze.

By contrast, curve F, as earlier stated, depicts the variation of resolution versus distance away from the X-mirror in the situation wherein the laser beam is focused to form the beam waist between the X-mirror 64 and the projection surface. Curve F demonstrates that the resolution reaches a maximum value Nmax at Zmax, and that the desired high resolution N is reached at a starting location Zs.

By comparing curves E and F, it will be noted that curve F reaches the resolution N at a starting distance closer to the X-mirror 64, that is, Zs is smaller than Ze. Also, curve F reaches its maximum resolution at a much closer distance Zmax, that is, Zmax is about twice the starting distance (Zmax=2Zs) and not very far away from the X-mirror.

Hence, curve F is the preferred approach to achieve a desired high resolution starting from a close-in starting location Zs and for maintaining that high resolution all the way to a far-away, i.e., infinite, location.

The relationship among the scan dimension Wo, the resolution N, and the scan angle θ can be expressed by the following relationship: Wo=2λN/πtan(θ/2). Hence, for a known scan angle θ, by selecting the value of the resolution N, the scan dimension Wo can be calculated.

In a preferred embodiment, to achieve a VGA or higher resolution of about 1000 over an extended viewing range, the size of the X-mirror should be larger than 0.9 mm. The preferred waist location Zo should be in a range of 100 mm to about 1.5 meters from the X-mirror. The scan dimension Wo should be from about 0.08 mm to about 1.2 mm.

It is also preferred that the scan dimension Wo of the beam waist be less than the size D of the X-mirror so that the laser beam is not clipped by the X-mirror. The optical throughput is to be maximized to create the image with maximum brightness.

The semiconductor lasers used in this arrangement have a very large beam divergence. Hence, the optical assembly modifies the laser beam to have a small beam divergence, which is equivalent to forming the laser beam with the desired beam waist size. Since the divergence angle is inversely related to the scan dimension Wo, the sizing of the scan dimension Wo also controls the size of the divergence angle and the resolution of the image. However, light rays at the edge of the beam divergence striking the peripheral edges of spherical optics will deviate from the on-axis rays, thereby rendering the beam waist large and reducing the resolution unless multiple optical elements are used. However, the use of multiple optical elements is not acceptable in a compact image projection arrangement where weight and size are important. Hence, the optics should have one or more aspheric surfaces.

It will be understood that each of the elements described above, or two or more together, also may find a useful application in other types of constructions differing from the types described above.

While the invention has been illustrated and described as embodied in an arrangement for and a method of projecting an image to be viewed on a projection surface over an extended viewing range, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

We claim:

1. An arrangement for projecting an image to be viewed on a projection surface over an extended viewing range, comprising:
a) a laser assembly for generating a laser beam;
b) a scanner including a scan mirror oscillatable about a scan axis, for sweeping the laser beam as a pattern of scan lines during oscillation of the scan mirror on the projection surface at a distance within the extended viewing range, each scan line having a plurality of pixels; and
c) a controller operatively connected to the laser assembly and the scanner, for causing selected pixels along the scan lines to be illuminated, and rendered visible, by the laser beam to produce the image; and
d) optics for optically modifying the laser beam to form each scan line with a desired high resolution having no less than a desired large number of the pixels over the extended viewing range, by focusing the laser beam to form a beam waist having a scan dimension proportional to the resolution at a focal location positioned between the scan mirror and the projection surface.

2. The image projection arrangement of claim 1, wherein the laser assembly includes a plurality of lasers for respectively generating a plurality of laser beams of different wavelengths, and wherein the optics is also operative for nearly collinearly arranging the laser beams to form the laser beam as a composite beam which is directed to the scan mirror.

3. The image projection arrangement of claim 2, wherein the lasers include red and blue, semiconductor lasers for respectively generating red and blue laser beams.

4. The image projection arrangement of claim 3, wherein the lasers include a diode-pumped YAG laser and an optical frequency doubler for producing a green laser beam.

5. The image projection arrangement of claim 2, wherein the scan mirror is operative for sweeping the composite beam along a first direction at a first scan rate and over a first scan angle, and wherein the scanner includes another oscillatable scan mirror for sweeping the composite beam along a second direction substantially perpendicular to the first direction, and at a second scan rate different from the first scan rate, and at a second scan angle different from the first scan angle.

6. The image projection arrangement of claim 5, wherein at least one of the scan mirrors is oscillated by an inertial drive.

7. The image projection arrangement of claim 5, and a support for supporting the laser assembly, the scanner, and the optics.

8. The image projection arrangement of claim 1, wherein the controller includes means for energizing the laser assembly to illuminate the selected pixels, and for deenergizing the laser assembly to non-illuminate pixels other than the selected pixels.

9. The image projection of claim 1, wherein the optics includes a lens having at least one aspheric surface.

10. An image projection arrangement for projecting a two-dimensional, color image to be viewed on a projection surface over an extended viewing range, comprising:
a) a support;
b) a laser assembly including red, blue and green lasers on the support, for respectively emitting a plurality of red, blue and green laser beams;
c) a scanner on the support, including a scan mirror oscillatable about a scan axis, for sweeping each laser beam in a pattern of scan lines during oscillation of the scan mirror on the projection surface at a distance within the extended viewing range, each scan line having a plurality of pixels; and
d) a controller operatively connected to the laser assembly and the scanner, for causing selected pixels to be illuminated, and rendered visible, by each laser beam to produce the image, the controller being operative for selecting at least some of the laser beams to illuminate the selected pixels to produce the image with color; and
e) an optical assembly on the support for optically modifying at least one of the laser beams to form each scan line with a desired high resolution having no less than a desired large number of the pixels over the extended viewing range, by focusing the at least one laser beam to form a beam waist having a scan dimension proportional to the resolution at a focal location positioned between the scan mirror and the projection surface.

11. The image projection arrangement of claim 10, wherein the scan mirror is operative for sweeping each laser beam along a first direction at a first scan rate and over a first scan angle, and wherein the scanner includes another oscillatable scan mirror for sweeping each laser beam along a second direction substantially perpendicular to the first direction, and at a second scan rate different from the first scan rate, and at a second scan angle different from the first scan angle.

12. The image projection arrangement of claim 11, wherein at least one of the scan mirrors is oscillated by an inertial drive.

13. The image projection arrangement of claim 10, wherein the optical assembly wherein the optics includes a lens having at least one aspheric surface.

14. An arrangement for projecting an image to be viewed on a projection surface over an extended viewing range, comprising:
a) laser means for generating a laser beam;
b) scanner means including a scan mirror oscillatable about a scan axis, for sweeping the laser beam as a pattern of scan lines during oscillation of the scan mirror on the projection surface at a distance within the extended viewing range, each scan line having a plurality of pixels; and
c) controller means operatively connected to the laser means and the scanner means, for causing selected pixels along the scan lines to be illuminated, and rendered visible, by the laser beam to produce the image; and
d) optical means for optically modifying the laser beam to form each scan line with a desired high resolution having no less than a desired large number of the pixels over the extended viewing range, by focusing the laser beam to form a beam waist having a scan dimension proportional to the resolution at a focal location positioned between the scan mirror and the projection surface.

15. An image projection module for projecting a two-dimensional image to be viewed on a projection surface over an extended viewing range, comprising:
a) a support;
b) a laser assembly on the support, for generating a laser beam;
c) a scanner on the support, including a scan mirror oscillatable about a scan axis, for sweeping the laser beam as a pattern of scan lines during oscillation of the scan mirror on the projection surface at a distance within the extended viewing range, each scan line having a plurality of pixels;
d) a controller operatively connected to the laser assembly and the scanner, for causing selected pixels along the scan lines to be illuminated, and rendered visible, by the laser beam to produce the image; and
e) optics on the support, for optically modifying the laser beam to form each scan line with a desired high resolution having no less than a desired large number of the pixels over the extended viewing range, by focusing the laser beam to form a beam waist having a scan dimension proportional to the resolution at a focal location positioned between the scan mirror and the projection surface.

16. A method of projecting a two-dimensional image to be viewed on a projection surface over an extended viewing range, comprising the steps of:
a) generating a laser beam;
b) sweeping the laser beam as a pattern of scan lines by oscillating a scan mirror about an axis, each scan line having a plurality of pixels;
c) causing selected pixels along the scan lines to be illuminated, and rendered visible, by the laser beams to produce the image; and
d) optically modifying the laser beam to form each scan line with a desired high resolution having no less than a desired large number of the pixels over the extended viewing range, by focusing the laser beam to form a beam waist having a scan dimension proportional to the resolution at a focal location positioned between the scan mirror and the projection surface.

17. The image projection method of claim 16, wherein the generating step is performed by generating a plurality of laser beams of different wavelengths, and the step of nearly collinearly arranging the laser beams to form the laser beam as a composite beam which is directed to the scan mirror.

18. The image projection method of claim 16, wherein the focusing step is performed by a lens having at least one aspheric surface.
